(19) United States
(12) Patent Application Publication
(10) Pub. No.: US 2017/0266741 A1
(43) Pub. Date: Sep. 21, 2017

(54) SLIDING TABLE TYPE CIRCULAR SAWING MACHINE

(71) Applicant: Bor-Yann CHUANG, TAICHUNG CITY (TW)

(72) Inventor: Bor-Yann CHUANG, TAICHUNG CITY (TW)

(21) Appl. No.: 15/075,408

(22) Filed: Mar. 21, 2016

(51) Int. Cl. B23D 47/02; B23D 45/06

(52) U.S. Cl. CPC B23D 47/025; B23D 45/062

(57) ABSTRACT

A sliding table type circular sawing machine includes a housing having one side assembled with a travelling mechanism and its interior provided with a first fixed seat, a second fixed seat and a third fixed seat spaced apart. A power mechanism is received in the housing and a circular saw blade protrudes out of the topside of the housing. The power mechanism is respectively connected with the second fixed seat and the circular saw blade so that a short distance can be maintained between the extreme and of the power mechanism and the circular saw blade. Thus, cooperating with the travelling mechanism that is able to quickly position a work piece, the sliding table type circular sawing machine of this invention is able to carry out successive sawing operation with quickness, with less labor and with simplicity, thus enhancing convenience of the sliding table type circular sawing machine.

### BACKGROUND OF THE INVENTION

1. Field of the Invention

This invention relates to a sliding table type circular sawing machine.

2. Description of the Prior Art

A conventional circular sawing machine includes a fundamental base having its interior formed with an accommodating space and its topside provided with a work table, which is bored with an elongated hole communicating with the accommodating space. The conventional circular sawing machine is further provided with a motor and a seat body received in the accommodating space, and a transmission shaft is inserted through the seat body and has one end connected with the output shaft of the motor by means of driving belt and another end fixed thereon with a circular saw blade protruding out of the elongated hole. Thus, when the motor is started to drive the circular saw blade to rotate, a work piece can be placed on the work table and then the work piece is pushed to move toward the circular saw blade for carrying out sawing operation. However, the conventional circular sawing machine is to have one end of the transmission shaft receiving the output power of the motor and have another end of the transmission shaft transmitting the output power of the motor to the circular saw blade. Thus, the distance between the motor and the circular saw blade is the total distance of the motor and the transmission shaft and as a result, when a travelling platform is provided on the work table for use, there will maintain a long distance between the travelling platform and the circular saw blade and in this case, the distance between the work piece and the circular saw blade will be restricted to influence the cutting sizes of the work piece. Further, the seat body of the conventional circular sawing machine is formed integral with high requirements in precision; therefore, it is difficult in manufacturing and high in cost. In view of the drawbacks mentioned above, the inventor of this invention thinks that the conventional circular sawing machine is necessary to be ameliorated and hence devises this invention.

### SUMMARY OF THE INVENTION

A major objective of this invention is to offer a sliding table type circular sawing machine, which includes a seat body provided with a first fixed seat, a second fixed seat and a third fixed seat spaced apart and thus, the sliding table type circular sawing machine can attain efficacy of easy processing and high precision. A minor objective of this invention is to offer a sliding table type circular sawing machine, which is provided with a travelling mechanism able to quickly position a work piece. Thus, by having the travelling mechanism cooperating with the seat body, the sliding table type circular sawing machine of this invention is economical in labor and simple in operation.

The sliding table type circular sawing machine in the present invention includes a housing formed with an accommodating space. The housing has its topside provided with a work table bored with an elongated hole communicating with the accommodating space. A seat body is received in the accommodating space, composed of a first fixed seat, a second fixed seat and a third fixed seat positioned separately. The first fixed seat is provided with two longitudinal shaft levers having their free ends inserted through the second fixed seat and secured with the third fixed seat. A power mechanism is received in the accommodating space and connected with the second fixed seat, and a circular saw blade is connected with the power mechanism and protrudes out of the elongated hole.

The sliding table type circular sawing machine of this invention is to have the power mechanism respectively connected with the second fixed seat and the circular saw blade, able to maintain a short distance between an extreme end of the power mechanism and the circular saw blade. Thus, by cooperating with the travelling mechanism that can position a work piece quickly, the sliding table type circular sawing machine of this invention is able to carry out successive sawing operation with quickness, with less labor and with simplicity, able to elevate convenience in operation of the sliding table type circular sawing machine.

### BRIEF DESCRIPTION OF DRAWINGS

This invention will be better understood by referring to the accompanying drawings, wherein:

FIG. 1 is a perspective view of a sliding table type circular sawing machine in the present invention;

FIG. 2 is a first partial exploded perspective view of the sliding table type circular sawing machine in the present invention;

FIG. 3 is a partial cross-sectional view of the sliding table type circular sawing machine in the present invention;

FIG. 4 is a second partial exploded perspective view of the sliding table type circular sawing machine in the present invention;

FIG. 5 is a third partial exploded perspective view of the sliding table type circular sawing machine in the present invention;

FIG. 6 is a schematic view showing that the sliding table type circular sawing machine carries out sawing operation of a work piece in the present invention;

FIG. 7 is a schematic view showing a using condition of a circular saw blade at a first location in the present invention;

FIG. 8 is a schematic view showing a using condition of the circular saw blade at a second location in the present invention; and

FIG. 9 is a schematic view showing that the circular saw blade is adjusted in rotation angles for use in the present invention.

### DETAILED DESCRIPTION OF THE PREFERRED EMBODIMENT

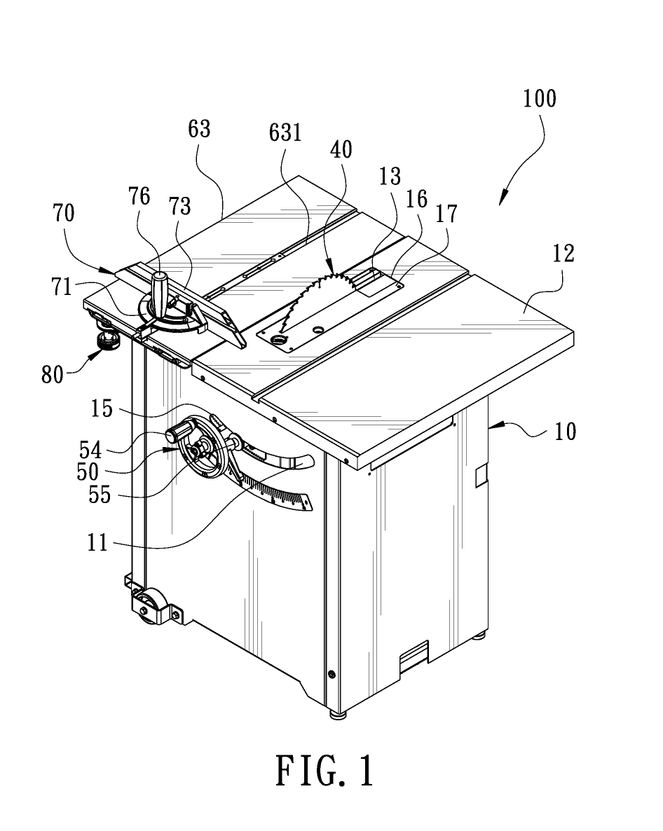

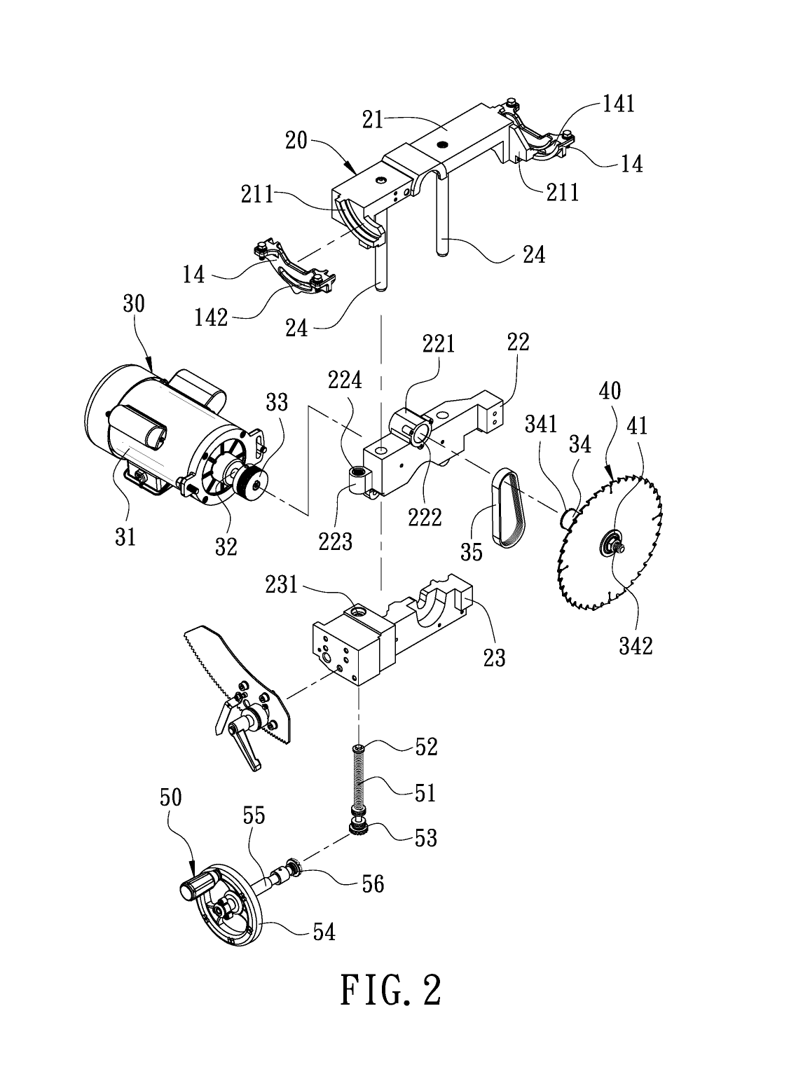

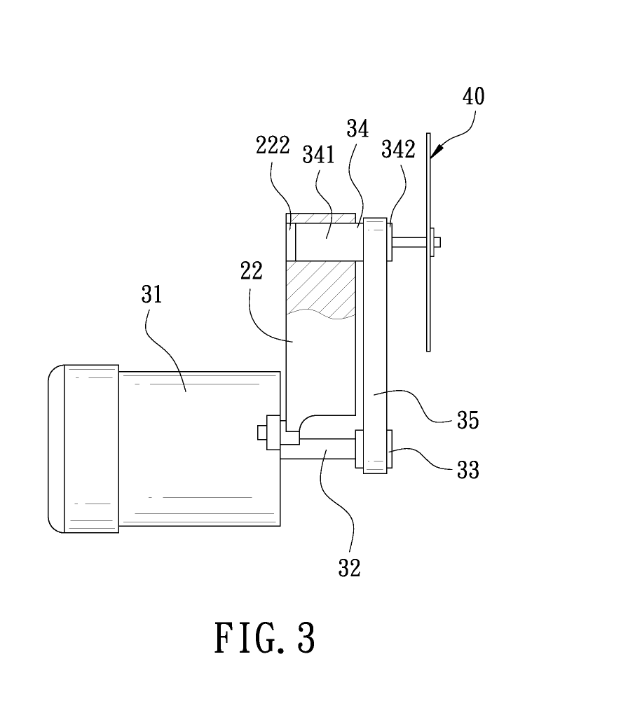

A preferred embodiment of a sliding table type circular sawing machine 100 in present invention, as shown in FIGS. 1, 2 and 3, includes a housing 10, a seat body 20, a power mechanism 30, a circular saw blade 40, a lifting mechanism 50, a travelling mechanism 60, a push member 70 and a brake member 80 as main components combined together.

The housing 10 has its interior formed with an accommodating space 11 and its topside provided with a work table 12, which is bored with an elongated hole 13 communicating with the accommodating space 11. In this prevention, the work table 12 of the housing 10 is provided with two adjustment members 14 spaced apart at the underside, and each adjustment member 14 has one side formed with an adjustment recess 141 bored therein with a first adjustment hole 142, both the adjustment recess 141 and the adjustment hole 142 being arc-shaped. Further, the housing 10 has a side wall bored with a second adjustment hole 15 that is arc-shaped corresponding to the first adjustment hole 142. Furthermore, the work table 12 is formed with a rectangular hole 16 fixed thereon with a flat plate 17 bored with the elongated hole 13.

The seat body 20 is received in the accommodating space 11, consisting of a first fixed seat 21, a second fixed seat 22 and a third fixed seat 23 spaced apart. The first fixed seat 12 is provided with two longitudinal shaft levers 24, which have their free ends inserted through the second fixed seat 22 and secured with the third fixed seat 23. In this invention, the adjustment members 14 are respectively positioned at two sides of the first fixed seat 21, and the first fixed seat 21 has two sides respectively provided with an adjustment block 211 corresponding to the adjustment recess 141 of the adjustment member 14. The second fixed seat 22 has a topside fixed thereon with a connecting block 221 with a connecting hoe 222 and provided with lifting block 223 with a threaded hole 224 at a location facing the side wall of the housing 10, and the third fixed seat 23 is bored with a through hole 231 corresponding with the threaded hole 224.

The power mechanism 30 is received in the accommodating space 11 and connected with the second fixed seat 22. In this invention, the power mechanism 30 contains a motor 31 fixed at a first side of the second fixed seat 22 and provided with an output shaft 32 extending toward a second side of the second fixed seat 22 and having its free end fitted with a driving wheel 33. The power mechanism 30 is further provided with a transmission shaft 34 having a fixed section 341 inserted in the connecting hole 222 and pivotally combined with the second fixed seat 22 and having a transmission section 342 protruding out of the second side of the second fixed seat 22. Both the driving wheel 33 and the transmission section 342 of the transmission shaft 34 are conjointly fitted thereon with a same driving belt 35.

The circular saw blade 40 is connected with the power mechanism 30 and protrudes out of the elongated hole 13. In this invention, the circular saw blade 40 is bored with a central hole 41, and the connecting hole 222 of the second fixed seat 22 and the central hole 41 of the circular saw blade 40 are concentric. The transmission section 342 of the transmission shaft 34 has its free end inserted through the central hole 41 and secured with the circular saw blade 40.

The lifting mechanism 50 positioned at one side of the seat body 20 is connected with the seat body 20 and longitudinally provided with a screw 51, which has a first end inserted through the threaded hole 224 of the second fixed seat 22 and provided thereon with a resisting member 52 and a second end inserted through the through hole 231 of the third fixed seat 23 and mounted thereon with a first gear 53. The lifting mechanism 50 further contains a hand wheel 54 positioned at the outer side of the housing 10 and provided with a rotating shaft 55 inserted through the second adjustment hole 15 of the housing 10. The rotating shaft 55 and the screw 51 are perpendicular to each other, and the rotating shaft 55 has its free end provided with a second gear 56 to be engaged with the first gear 53.

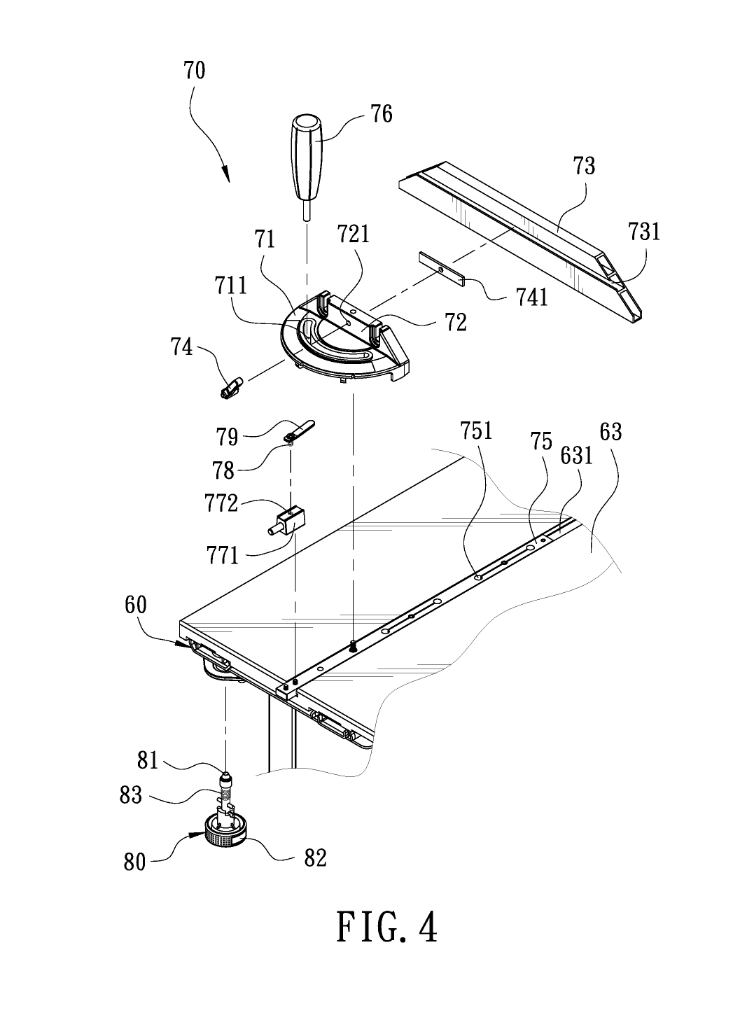

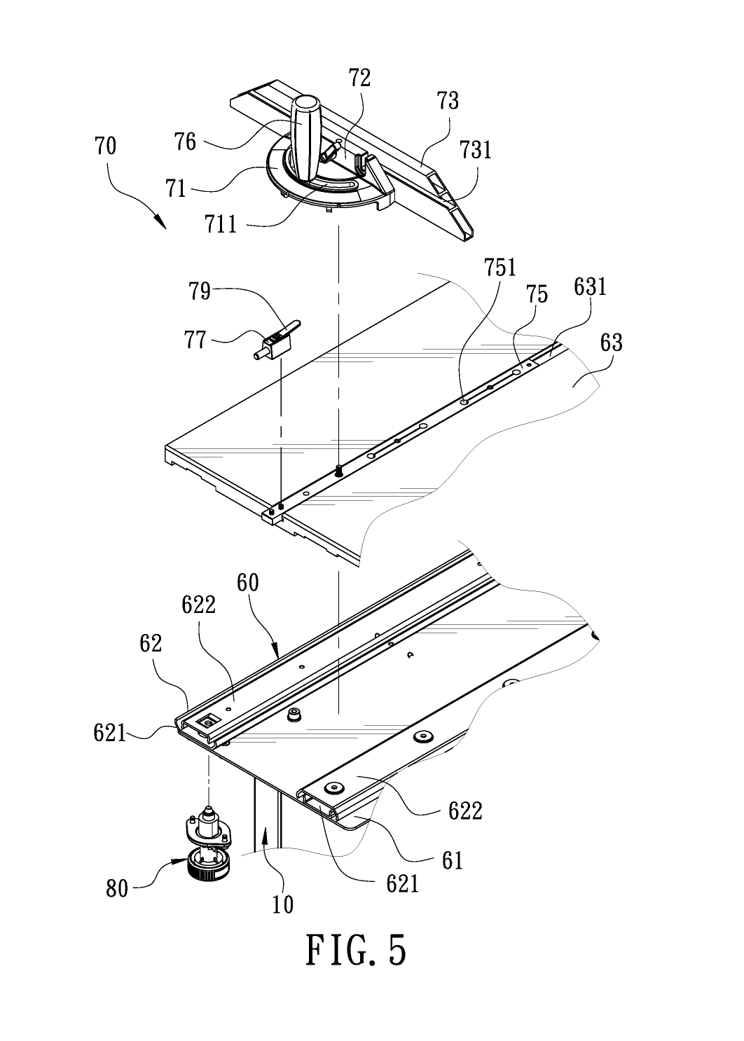

The travelling mechanism 60 is provided at one side of the work table 12, adjacent to the circular saw blade 40, referring to FIGS. 4 and 5 as well as FIGS. 1-3. The travelling mechanism 60 is composed of a fixed plate 61, two sliding rails 62 and a sliding table 63. The fixed plate 61 is secured with the housing 10, and the two sliding rails 62 respectively contain a fixed section 621 and a sliding section 622. The fixed sections 621 of the two sliding rails 62 are parallel to the elongated hole 13 and separately disposed at the topside of the fixed plate 61, and the sliding sections 622 of the two sliding rails 62 are set at the underside of the sliding table 63 so that the sliding table 63 can be slidably mounted on the fixed plate 61. The sliding table 63 is formed with a positioning groove 631 parallel to the elongated hole 13.

The push member 70 to be fixed with the sliding table 63, including a base 71 is bored with an arcuate third adjustment hole 711 and has one side fixed with a combining block 72 with a combining hole 721. The push member 70 is further provided with a push plate 73 perpendicular to the sliding rail 62 and bored with a transverse engage recess 731 corresponding to the combining hole 721. In addition, the push member 70 is provided with a first position-limiting rod 74 and a position-limiting plate 741 corresponding to the engage recess 731. The first position-limiting rod 74 is inserted through the combining hole 721 and restrictedly positioned in the engage recess 731 via the position-limiting plate 741. The push member 70 further contains a positioning plate 75 fixed on the positioning groove 631 and bored with a plurality of positioning holes 751 spaced apart and corresponding to the third adjustment hole 711, and is provided with a second position-limiting rod 76 to be inserted through the third adjustment hole 711 and the positioning hole 751 to have the base 71 combined with the positioning plate 75 and secured with the sliding table 63. Moreover, the push member 70 consists of a stop member 77 formed with a stop block 771 to be secured on the positioning plate 75. The stop block 771 is bored with an insert hole 772 facing the positioning plate 75, and a fixing rod 78 is inserted through the insert hole 772 and has one end screwed with the positioning plate 75. A press piece 79 is mounted at the topside of the stop block 771, having a first end screwed with the stop block 771 and a free end slanting upward.

The brake member 80 to be assembled at the underside of the fixed plate 61 contains a press bar 81 having a first end provided with a push button 82 and fitted thereon with a spring 83 and having a second end inserted into the fixed section 621 of the sliding rail 62. When the push button 82 is pressed, the second end of press bar 81 will resist against the sliding section 622 of the sliding rail 62.

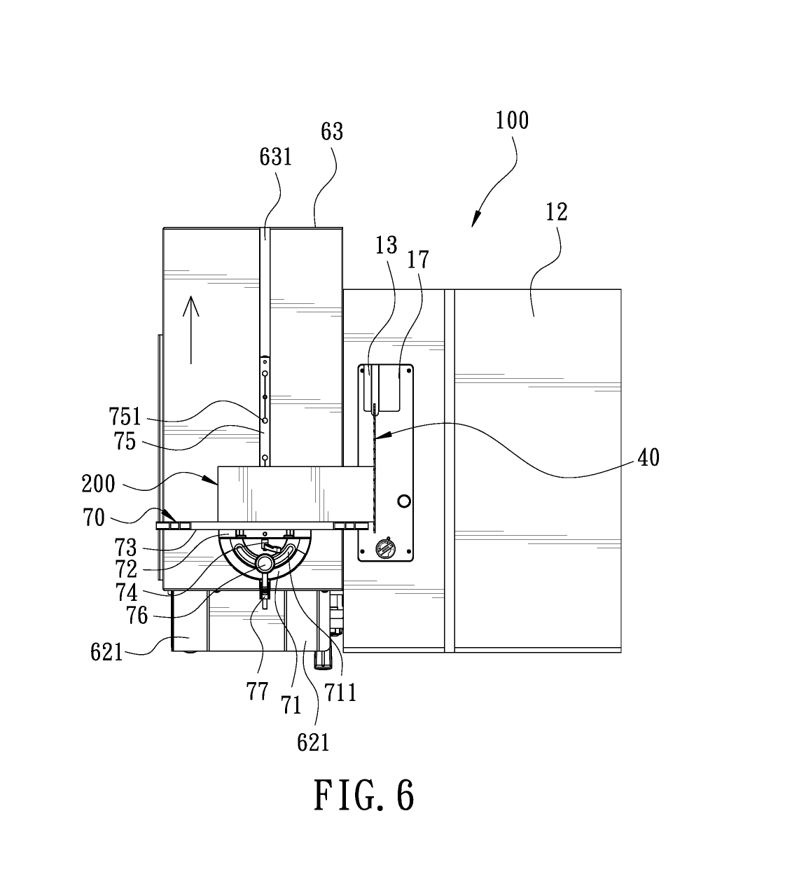

In operating, referring to FIG. 6, firstly, start the motor 31 to drive the circular saw blade 40 to rotate and then have a work piece 200 pushed by the push plate 73 to be quickly positioned at the sliding table 63 and then, move the push member 70 to actuate the sliding table 63 to move toward the circular saw blade 40, thus able to carry out successive sawing operation with quickness, with less labor and with simplicity.

This invention is to have the motor 31 secured at a first side of the second fixed seat 22 and have the output shaft 32 of the motor 31 extending toward a second side of the second fixed seat 22, and the fixed section 341 of the transmission shaft 34 of the motor 31 is inserted in the connecting hole 222 and secured with the second fixed seat 22, while the transmission section 342 of the transmission shaft 34 protrudes out of the second side of the second fixed seat 22. By so designing, the output shaft 32 and the transmission shaft 34 of the motor 31 are partially overlapped along the horizontal plane of the housing 10, thus shortening the distance between the motor 31 and the circular saw blade 40 and maintaining a short distance between the sliding table 63 and the circular saw blade 40. The short distance is between 50 mm and 70 mm and in a preferred embodiment, the short distance is 59 mm, thus able to enhance convenience of the sliding table type circular sawing machine 100.

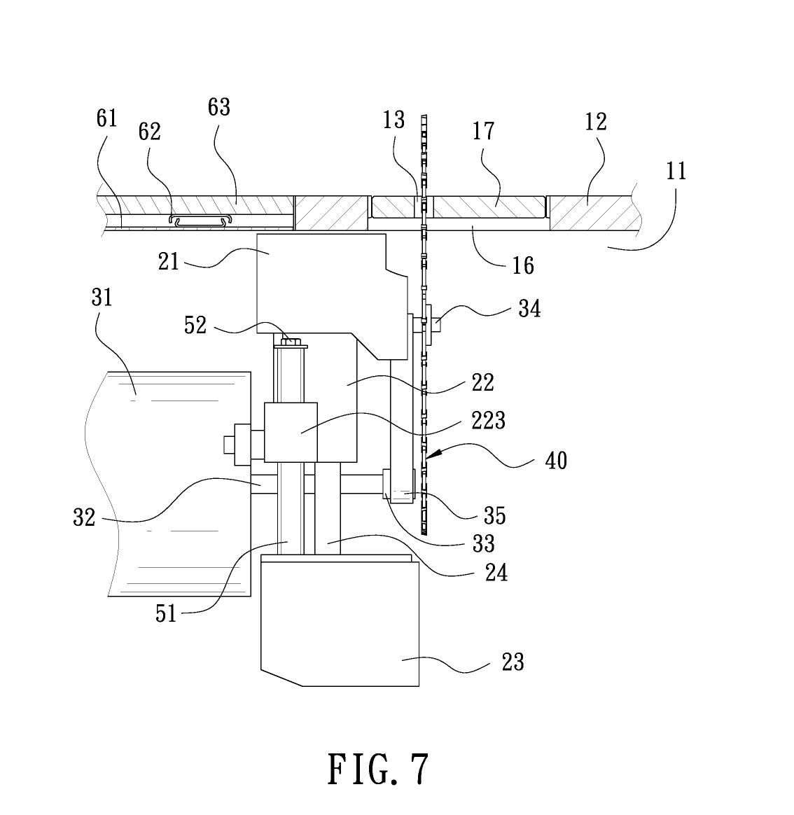

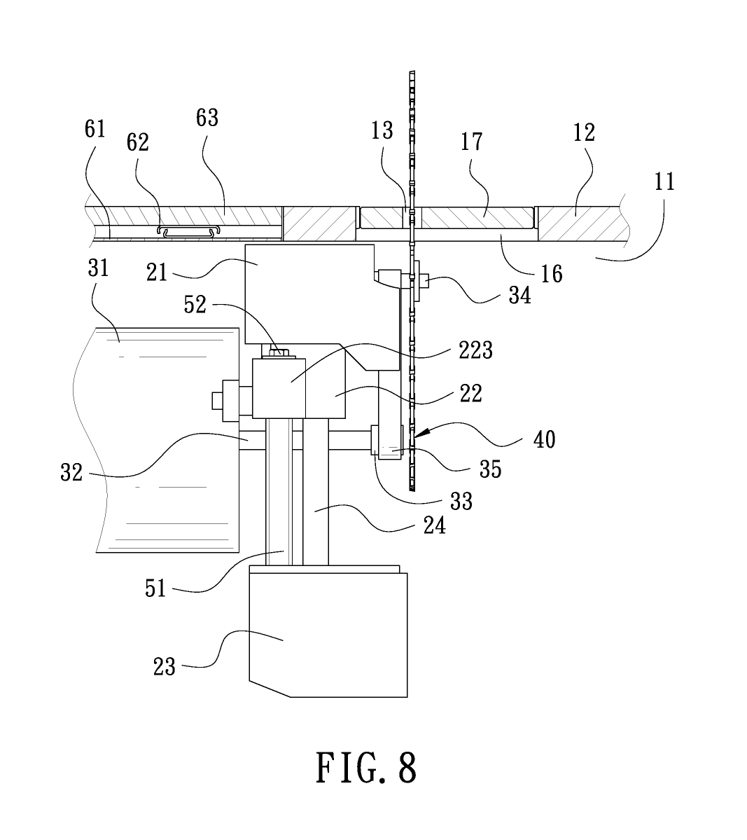

FIGS. 7 and 8 respectively show a using state of a first location and a second location of the sliding table type circular sawing machine 100 of this invention. To adjust a lifting position of the circular saw blade 40, turn the hand wheel 54 of the lifting mechanism 50 to drive the rotating shaft 55 and the second gear 56 to rotate. Simultaneously, the second gear 56 will actuate the first gear 53 and the screw 51 to rotate to enable the second fixed seat 22 to move longitudinally between the first fixed seat 21 and the third fixed seat 23, letting the second fixed seat 22 actuate the circular saw blade 40 to move upward and downward, thus able to hoist and lower the circular saw blade 40.

The seat body 20 of this invention consists of the first fixed seat 21, the second fixed seat 22 and the third fixed seat 23 positioned separately and connected by means of the shaft levers 24 and the screw 51; therefore, this invention is easy in processing and low in cost.

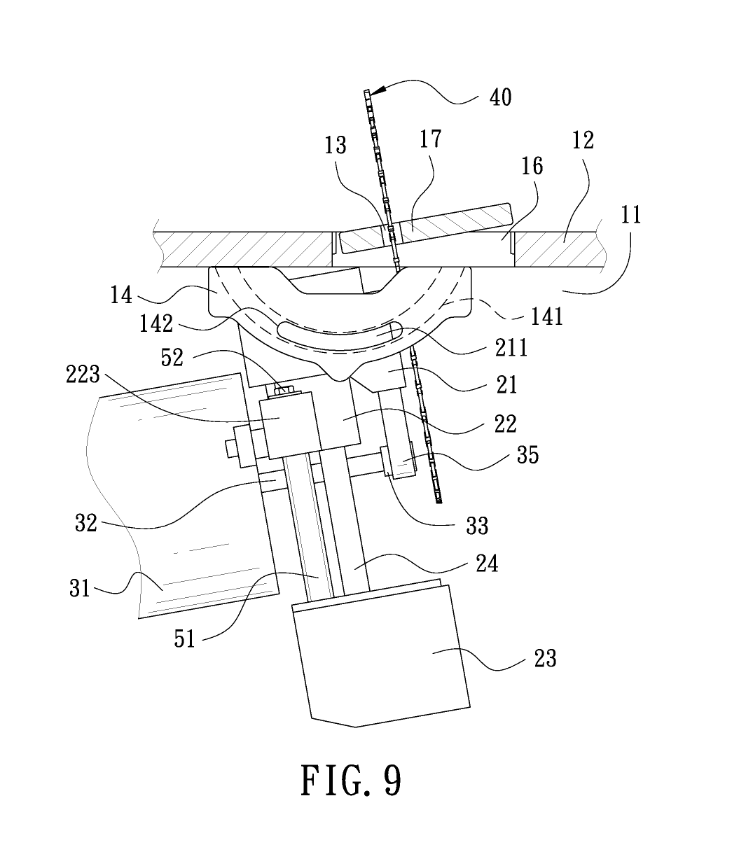

FIG. 9 shows that the circular saw blade 40 is adjusted in rotation angles for use. To adjust the rotation angles of the circular saw blade 40, simply have the hand wheel 54 shifting in the second adjustment hole 15 and actuating the seat body 20, letting the adjustment block 211 of the first fixed seat 21 move in the adjustment recess 141 of the adjustment member 14 and synchronously rotate the seat body 20, the flat plate 17 and the circular saw blade 40, thus adjusting the rotation angles of the circular saw blade 40.

Thus, this invention has the motor 31 secured at a first side of the second fixed seat 22 and the fixed section 341 of the transmission shaft 34 is inserted in the connecting hole 222 and secured with the second fixed seat 22, while the transmission section 342 of the transmission shaft 34 protrudes out a second side of the second fixed seat 22, letting the output shaft 32 and the transmission shaft 34 partially overlapped along the horizontal plane of the housing 10 and hence shorting the distance between the motor 31 and the circular saw blade 40 and maintaining a short distance between the sliding table 63 and the circular saw blade 40. And cooperating with the travelling mechanism 60 that is able to quickly position the work piece 200, the sliding table type circular sawing machine 100 of this invention can carry out successive sawing operation with quickness, with less labor and with simplicity, thus elevating convenience of the sliding table type circular sawing machine 100.

While the preferred embodiment of the invention has been described above, it will be recognized and understood that various modifications may be made therein and the appended claims are intended to cover all such modifications that may fall within the spirit and scope of the invention.

What is claimed is:

1. A sliding table type circular sawing machine comprising:
a housing formed with a accommodating space, said housing having a topside provided with a work table, said work table bored with an elongated hole communicating with said accommodating space;
a seat body received in said accommodating space, said seat body containing a first fixed seat, a second fixed seat and a third fixed seat positioned spaced apart, said first fixed seat provided with two longitudinal shaft levers, said shaft levers having their free ends inserted through said second fixed seat and secured with said third fixed seat;
a power mechanism received in said accommodating space, said power mechanism connected with said second fixed seat; and
a circular saw blade connected with said power mechanism, said circular saw blade protruding out of said elongated hole;
Thus, by having said first fixed seat and said second fixed seat and said third fixed seat provided separately, this invention able to attain efficacy of easy processing and high precision.

2. The sliding table type circular sawing machine as claimed in claim 1, wherein said housing is provided with two adjustment members respectively at two sides of said first fixed seat, each said adjustment member having one side formed with an adjustment recess, said adjustment recess bored with a first adjustment hole, said adjustment recess and said first adjustment hole being arc-shaped, said first fixed seat provided with an adjustment block corresponding with said adjustment recess.

3. The sliding table type circular sawing machine as claimed in claim 1, wherein said second fixed seat has a topside fixed with a connecting block, said connecting block bored with a connecting hole corresponding to a center of said circular saw blade.

4. The sliding table type circular sawing machine as claimed in claim 3, wherein said power mechanism contains a motor, said motor secured at a first side of said second fixed seat, said motor provided with an output shaft extending toward a second side of said second fixed seat, said output shaft having a free end fitted thereon with a driving wheel, said power mechanism further including a transmission shaft, said transmission shaft having a fixed section inserted in said connecting hole of said second fixed seat and secured with said second fixed seat, said transmission shaft having a transmission section protruding out of the second side of said second fixed seat, said driving wheel and said transmission section of said transmission shaft conjointly fitted with a same driving belt, said transmission section of said transmission shaft having a free end inserted through a center of said circular saw blade and secured with said circular saw blade.

5. The sliding table type circular sawing machine as claimed in claim 2, wherein a lifting mechanism is further provided at one side of said seat body and connected with said seat body, said lifting mechanism provided with a longitudinal screw, said screw having a first end inserted in said second fixed seat and fixed thereon with a resisting member, said screw having a second end inserted through said third fixed seat and provided with a first gear, said lifting mechanism further consisting of a hand wheel positioned at an outer side of said housing, said housing having a sidewall bored with a second adjustment hole, said second adjustment hole being arc-shaped corresponding with said first adjustment hole of said adjustment member, said hand wheel provided with a rotating shaft inserted in said second adjustment hole of said housing, said rotating shaft and said screw perpendicular to each other, said rotating shaft having a free end formed with a second gear, said second gear engaged with first gear.

6. The sliding table type circular sawing machine as claimed in claim 5, wherein said second fixed seat is provided with a lifting block at a location facing a side wall of said housing, said lifting block formed with a threaded hole, said screw having a first end inserted in said threaded hole, said third fixed seat bored with a through hole corresponding with said threaded hole, said screw having a second end inserted through said through hole.

7. The sliding table type circular sawing machine as claimed in claim 1, wherein said sliding table type circular sawing machine further contains a travelling mechanism, said travelling mechanism assembled at one side of said work table, said travelling mechanism composed of a fixed plate, two sliding trails and sliding table, said fixed plate secured with said housing, said sliding rail consisting of a fixed section and a sliding section, said fixed sections of said two sliding rails parallel to said elongated hole and separately disposed at topsides of said fixed plate, said sliding sections of said two sliding rails provided at undersides of said sliding table to enable said sliding table to be slidably positioned on said fixed plate via said sliding rails, said sliding table bored with a positioning groove parallel to said elongated hole.

8. The sliding table type circular sawing machine as claimed in claim 7, wherein said sliding table type circular sawing machine further includes a push member fixed with said sliding table, said push member formed with a base, said base bored with an arcuate third adjustment hole, said base having one side fixed with a combining block, said combining block formed with a combining hole, said push member further provided with a push plate perpendicular to said sliding rail, said push plate bored with a transverse engage recess corresponding to said combining hole, said push member further provided with a first position-limiting rod and a position-limiting plate corresponding to said engage recess, said first position-limiting rod inserted in said combining hole and restrictedly positioned in said engage recess via said position-limiting plate, said push member further having a positioning plate provided at said positioning groove of said sliding table, said positioning plate bored with a plurality of positioning holes spaced apart and corresponding to said third adjustment hole, said push member also provided with a second position-limiting rod, said second position-limiting rod inserted through both said third adjustment hole and said positioning hole to have said base combined with said positioning plate and secured at said sliding table.

9. The sliding table type circular sawing machine as claimed in claim 8, wherein said push member further contains a stop member, said stop member formed with a stop block, said stop member secured with said positioning plate, said stop block bored with an insert hole facing said positioning plate, said insert hole inserted therein with a fixing rod, said fixing rod having one end screwed with said positioning plate, a press sheet provided at a topside of said stop block, said press sheet having a first end screwed with said stop block, said press sheet having a free end slanting upward.

10. The sliding table type circular sawing machine as claimed in claim 7, wherein said sliding table type circular sawing machine is further provided with a brake member, said brake member fixed at an underside of said fixed plate, said brake member containing a press bar, said press bar having a first end provided with a press button, said press bar fitted thereon with a spring, said press bar having a second end inserted in said fixed section of said sliding rail, the second end of said press bar resisting against said sliding section of said sliding rail when said press button is pressed.
